(19) United States
(12) Patent Application Publication
(10) Pub. No.: US 2017/0168682 A1
(43) Pub. Date: Jun. 15, 2017

(54) METHOD AND ELECTRONIC DEVICE FOR CONTROLLING SHORTCUT SWITCH

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Junwei LIU, Beijing (CN)

(21) Appl. No.: 15/243,123

(22) Filed: Aug. 22, 2016

Related U.S. Application Data
(63) Continuation of application No. PCT/CN2016/088623, filed on Jul. 5, 2016.

(30) Foreign Application Priority Data
Dec. 15, 2015 (CN) 201510937959.2

(51) Int. Cl. G06F 3/0484; G06F 3/0481

(52) U.S. Cl. CPC G06F 3/04842; G06F 3/04817; G06F 3/04883

(57) ABSTRACT

This application discloses a method and an electronic device for controlling a shortcut switch. The controlling method includes: monitoring a shortcut switch click event; determining whether the shortcut switch click event satisfies a set extension rule if the occurrence of the shortcut switch click event is monitored; and displaying a function setting interface for the shortcut switch if the shortcut switch click event satisfies the set extension rule.

### CROSS-REFERENCES TO RELATED APPLICATIONS

This application is a continuation of International Application No. PCT/CN2016/088623, filed on Jul. 5, 2016, which is based upon and claims priority to Chinese Patent Application No. 201510937959.2, filed on Dec. 15, 2015, the entire contents of which are incorporated herein by reference.

### TECHNICAL FIELD

The application relates to intelligent terminal technology, for example, to a method and an electronic device for controlling a shortcut switch.

### BACKGROUND

With the development of mobile communication technology, mobile devices, such as a mobile phone, a tablet computer have been widely applied. Consequently, the user's convenient operational requirements on the intelligent terminal have become problems urgently to be solved by intelligent terminal vendors at present.

In the process of implementing this application, the inventor finds at least the following problems in the prior art: if one setting, such as setting a wireless network connection is changed on the relevant intelligent terminal, the user needs to click a setting icon to enter a setting interface, select a wireless local area network (WLAN) icon in the setting interface to enter a WLAN interface, and then click the wireless network to be connected to complete the connection. In the above process, the user needs to perform at least three click operations, and therefore the user operation is very cumbersome. For another example, if the user wants to enable a Bluetooth function, the user needs to click a setting icon to enter a setting interface, click the Bluetooth option in the setting interface to enter a setting interface for the Bluetooth function, click the enabling option to enable the Bluetooth, and then click a Bluetooth device name to be connected to perform the Bluetooth connection. If the user doesn't know the position where the function icon to be changed is located, the user needs to search in the setting interface repeatedly, so that the user operation can be cumbersome, and the user experience is poor.

### SUMMARY

This application provides a method and an electronic device for controlling a shortcut switch, achieving to display the function setting interface for the shortcut switch rapidly and conveniently, reducing operational costs of the user, and improving user's application experience.

In a first aspect, embodiments of this application provide a method for controlling a shortcut switch, which includes:

at an electronic device for controlling the shortcut switch:

monitoring a shortcut switch click event;

determining whether the shortcut switch click event satisfies a set extension rule if the occurrence of the shortcut switch click event is monitored; and

displaying a function setting interface for the shortcut switch, if the shortcut switch click event satisfies the set extension rule.

In a second aspect, embodiments of this application also provide an electronic device for controlling a shortcut switch, which includes:

at least one processor; and

a memory communicably connected with the at least one processor for storing instructions executable by the at least one processor, wherein execution of the instructions by the at least one processor causes the at least one processor to:

monitor a shortcut switch click event;

determine whether the shortcut switch click event satisfies a set extension rule if the occurrence of the shortcut switch click event is monitored; and

display the function setting interface for the shortcut switch if the shortcut switch click event satisfies the set extension rule.

In a third aspect, embodiments of this application also provide a non-transitory computer-readable storage medium storing computer-executable instructions that, when executed by an electronic device, cause the electronic device to:

monitor a shortcut switch click event;

determine whether the shortcut switch click event satisfies a set extension rule if the occurrence of the shortcut switch click event is monitored; and

display the function setting interface for the shortcut switch if the shortcut switch click event satisfies the set extension rule.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for controlling a shortcut switch according to some embodiments of this application;

FIG. 2 is a flowchart of a method for controlling a shortcut switch according to some embodiments of this application;

FIG. 3 is a structural schematic diagram of a device for controlling a shortcut switch according to some embodiments of this application; and

FIG. 4 is a structural schematic diagram of hardware of a device for performing a method for controlling a shortcut switch according to some embodiments of this application.

### DETAILED DESCRIPTION

Hereinafter, this application will be explained in detail with reference to the accompanying drawings and embodiments. It should be appreciated that the embodiments described herein are merely for explaining this application but are not intended to be limit this application. It should be additionally understood that, for illustrative purposes, only those portions relevant to this application, not all the structures are shown in the accompanying drawings.

### The First Embodiment

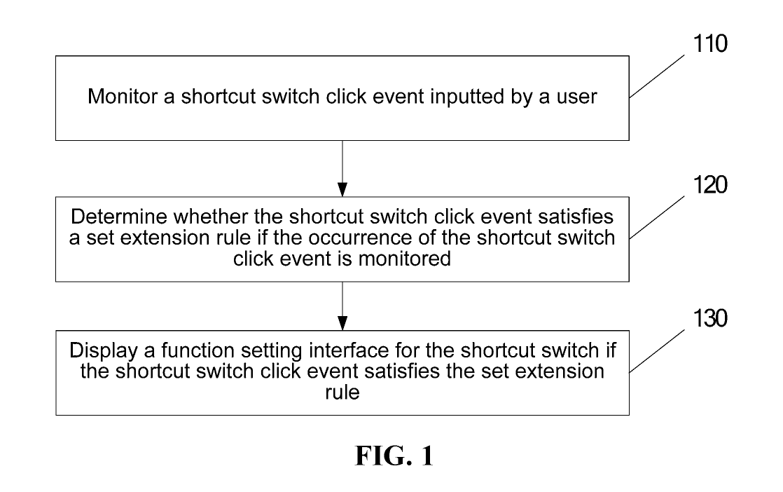

FIG. 1 is a flowchart of a method for controlling a shortcut switch according to some embodiments of this application. This embodiment is applicable to direct entrance to the function setting interface for the shortcut switch by operating shortcut switch. The method can be performed by a device for controlling a shortcut switch, and the device is configured within an intelligent terminal and can be implemented by hardware and/or software. The method for controlling the shortcut switch includes steps as follows:

In Step 110, a shortcut switch click event inputted by a user is monitored.

The shortcut switch click event includes a single-click shortcut switch event, a several-click (two or more) shortcut switch event and/or a long press shortcut switch (the time for pressing the shortcut switch exceeds a preset time threshold) event and so on.

The shortcut switch includes a shortcut operation icon, of which a function setting option is displayed in a state column or a control center of the intelligent terminal in the setting interface, for example, a wireless local area network (WLAN) icon, a sound function icon, a mobile data icon, a flashlight icon, a lightness icon and a global positioning system (GPS) icon displayed in the control center of the intelligent terminal.

For example, when detecting an instruction inputted by a user in the control center, the intelligent terminal displays a control center including a shortcut operation icon. If detecting a user's touch operation on a touch screen, the intelligent terminal determines a shortcut switch displayed in the control center corresponding to the touch point, based on a coordinate of a touch point, and triggers the shortcut switch click event. At this time, the intelligent terminal starts a monitoring thread to monitor the shortcut switch click event. For example, the intelligent terminal starts a monitoring thread to record the number of user's clicks on the touch switch within a preset time length, a duration time of each click operation (for example, an time interval from the user's pressing the touch screen each time to the finger's leaving the touch screen serves as the duration time of each click operation), and an interval time between two click operations.

In Step 120, whether the shortcut switch click event satisfies a set extension rule is determined if the occurrence of the shortcut switch click event is monitored.

The extension rule includes judging whether the click duration time of the shortcut switch click event exceeds the preset time threshold, or, the extension rule also can include judging whether the number of user's clicks on the touch switch within the preset time length is equal to the number of the preset clicks.

The intelligent terminal starts a preset timer when the occurrence of the shortcut switch click event is monitored; stops the timer when the termination of the shortcut switch click event is determined, and takes the time recorded by the timer as a duration time of the shortcut switch click event; and judges whether the duration time exceeds to the preset time threshold. For example, the preset time threshold can be 500 milliseconds. If detecting a shortcut switch click event, the intelligent terminal starts the preset timer to start timing. If detecting a termination of the shortcut switch click event, the intelligent terminal stops the timer to end timing, then the time recorded by the timer is 800 ms, that is, the duration time of the shortcut switch click event. Since the duration time of the shortcut switch click event exceeds the preset time threshold of 500 milliseconds, the shortcut switch click event is determined to satisfy the set extension rule.

If the intelligent terminal monitors the occurrence of the shortcut switch click event, the intelligent terminal starts the preset timer and counter; the intelligent terminal records the number of click operations included in the shortcut switch click event within the time length set in the timer; and judges whether the number exceeds a preset number threshold. For example, the extension rule can be preset that the number threshold for the user's click operations on the shortcut switch within 300 milliseconds is twice. When detecting a shortcut switch click event, the intelligent terminal starts the preset timer to start timing of 300 milliseconds, and the counter value is incremented by 1. Within the time length of the timer, whether the intelligent terminal detect another click operations on the shortcut switch is judged; if the intelligent terminal detects another click operations on the shortcut switch, the counter value is incremented by 1 on the basis of the recorded value; if the intelligent terminal doesn't detect another click operations on the shortcut switch, the value recorded by the counter remains unchanged. When the time set by the timer is arrived, the intelligent terminal acquires the value recorded by the counter and compares it with the preset times threshold, and judges whether the number of click operations included in the shortcut switch click event is equal to the preset times threshold. If the intelligent terminal detects that the user clicks the shortcut switch twice within 300 milliseconds, then determine the shortcut switch click event satisfies the set extension rule. If the intelligent terminal detects that the user clicks the shortcut switch more than twice within 300 milliseconds, then the time taken for the previous two click operations is inevitably less than the preset time of 300 milliseconds, it indicates that the number of the user's click operations on the shortcut switch has reached twice within the preset 300 milliseconds, and determines the shortcut switch click event satisfies the set extension rule. If the intelligent terminal detects that the user clicks the shortcut switch once within 300 milliseconds, then determine the shortcut switch click event doesn't satisfy the set extension rule.

In Step 130, the function setting interface for the shortcut switch is displayed, if the shortcut switch click event satisfies the set extension rule.

The function setting interface is a sub-page associated with the shortcut switch, and the sub-page includes detailed setting information of the shortcut switch. For example, for a GPS switch, the function setting interface includes an option whether to turn on a global positioning system service, an option for a positioning mode, an option whether to allow a positioning service while running in the background, etc. For another example, for a WLAN switch, the function setting interface includes an option whether to turn on a wireless local area network service, and display a connectable wireless network, etc.

When the intelligent terminal determines a shortcut switch click event satisfies a set extension rule, switches the current display interface to the function setting interface for the shortcut switch. For example, when the current display interface is a call record interface, if the intelligent terminal detects the user's shortcut switch click event on the sound function satisfies the set extension rule, then switches the current display interface from the call record interface to the sound function setting interface, to allow the user to reset the phone sound. Therefore, the user doesn't have to perform a series of cumbersome operations of exiting the call record interface, returning to the main interface, selecting the setting icon to enter the setting interface, selecting a sound function option in the setting interface to enter the sound function setting interface. Moreover, after completing the resetting of the phone sound, the user can exit the function setting interface and return directly to the call record interface, and continue to perform operations on the call record, improving the user's application experience, and without adding the number of the user's operations.

In this embodiment, a shortcut switch click event inputted by a user is monitored; whether the shortcut switch click event satisfies a set extension rule is determined if the occurrence of the shortcut switch click event is monitored; the function setting interface for the shortcut switch is displayed if the shortcut switch click event satisfies the set extension rule, avoiding the cumbersome operations that the user must select the icon in sequence via the setting interface to enter the function setting interface, displaying rapidly and conveniently the function setting interface for the shortcut switch, such that the user's operation can be more convenient, and user's application experience can be improved.

On the basis of the above technical solutions, after determining whether the shortcut switch click event satisfies the set extension rule, optionally, steps of changing an opened or closed state of a service corresponding to the shortcut switch click event can be added if the shortcut switch click event doesn't satisfy the set extension rule, achieving to open or close a service corresponding to the shortcut switch rapidly by the shortcut switch.

### The Second Embodiment

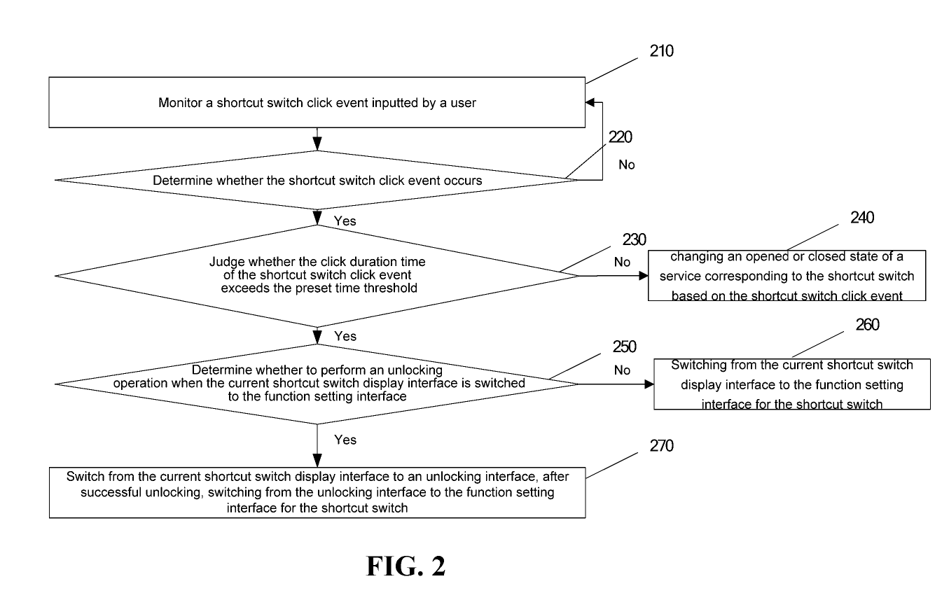

FIG. 2 is a flowchart of a method for controlling a shortcut switch according to the some embodiments of this application. In the technical solutions of this embodiment, interface switching steps are described on the basis of the above embodiments.

In Step 210, a shortcut switch click event inputted by a user is monitored.

Whether the intelligent terminal is in a sleep state or a normal operating state, when the intelligent terminal detects a shortcut switch display instruction inputted by the user, then enters a shortcut switch display interface. The intelligent terminal starts a scanning thread to scan the touch screen according to a preset period via the scanning thread. If the scanning thread scans the user's touch operations on the shortcut switch within the preset period, the scanning thread returns to a set valid value. If the scanning thread fails to scan the user's touch operations on the shortcut switch within the preset period, the scanning thread returns to a set invalid value.

In Step 220, whether the shortcut switch click event occurs is determined, if yes, step 230 is performed, if no, step 210 is performed.

If the intelligent terminal detects the set valid value returned by the scanning thread, a shortcut switch click event is generated while a monitoring thread is started to monitor the shortcut switch click event, thereby continuing step 230. For example, the intelligent terminal detects the user presses the WLAN switch in the control center, and generates a shortcut switch click event for the WLAN switch. Meanwhile, the intelligent terminal starts the monitoring thread to monitor a duration time of the shortcut switch click event, the number of user's clicks on the touch switch within a preset time length and/or an interval time between two click operations.

If the intelligent terminal detects the set invalid value returned by the scanning thread, the intelligent terminal returns to perform step 210.

In Step 230, whether the click duration time of the shortcut switch click event exceeds the preset time threshold is judged, if yes, step 250 is performed, if no, step 240 is performed.

If the intelligent terminal monitors the occurrence of the shortcut switch click event, the intelligent terminal starts the preset timer to start timing via the monitoring thread. The intelligent terminal stops the timer when the monitoring thread determines the shortcut switch click event is terminated, and takes the time recorded by the timer as the duration time of the shortcut switch click event. The monitoring thread returns the duration time of the shortcut switch click event to the intelligent terminal. The intelligent terminal compares the duration time with the preset time threshold. When the duration time exceeds the preset time threshold, step 250 is performed. When the duration time is less than the preset time threshold, step 240 is performed. For example, the user's preset time threshold is 300 milliseconds. If the intelligent terminal acquires the duration time of the shortcut switch click event inputted by the user to be 400 milliseconds, which exceeds the preset time threshold of 300 milliseconds, step 250 is performed. If the intelligent terminal acquires the duration time of the shortcut switch click event inputted by the user to be 150 milliseconds, which is less than the preset time threshold of 300 milliseconds, step 240 is performed.

In Step 240, an opened or closed state of a service corresponding to the shortcut switch is changed based on the shortcut switch click event.

When the click duration time of the shortcut switch click event acquired by the intelligent terminal is less than the preset time threshold, the shortcut switch click event inputted by the user is determined to be used for changing the opened or closed state of a service corresponding to the shortcut switch click event. For example, if the click duration time of the shortcut switch click event for the GPS switch acquired by the intelligent terminal is less than the preset time threshold, the user is determined to singly-click the GPS switch. Meanwhile, the intelligent terminal acquires the current GPS service is in a closed state at present, generates an opening instruction for opening the GPS service based on the GPS single-click operation inputted by the user, and opens the GPS service based on the opening instruction. Likewise, if the intelligent terminal acquires the current GPS service is in an opened state at present, generates a closing instruction for closing the GPS service based on the GPS single-click operation inputted by the user, and closes the GPS service based on the closing instruction.

In Step 250, whether to perform an unlocking operation is determined when the current shortcut switch display interface is switched to the function setting interface, if yes, step 270 is perform, if no, step 260 is performed.

The intelligent terminal determines whether the user starts a screen locking service. When the intelligent terminal is awaken from a sleep state, if the user starts the screen locking service, the intelligent terminal judges the click duration time of the shortcut switch click event exceeds the preset time threshold, step 270 is performed. If the user doesn't start the screen locking service, the intelligent terminal judges the click duration time of the shortcut switch click event exceeds the preset time threshold, step 260 is performed.

In Step 260, the interface is switched from the current shortcut switch display interface to the function setting interface for the shortcut switch.

In the case that the intelligent terminal determines the user does not start the screen locking service, when the intelligent terminal is awaken from a sleep state, if the intelligent terminal judges the click duration time of the shortcut switch click event exceeds the preset time threshold, the current shortcut switch display interface is switched directly to the function setting interface for the shortcut switch. For example, if the duration time for user's click on the GPS switch in the shortcut switch display interface exceeds the preset threshold, the intelligent terminal controls the current display interface to be switched from the shortcut switch display interface to the function setting interface for the GPS switch.

In Step 270, the interface is switched from the current shortcut switch display interface to an unlocking interface, and after successful unlocking, the interface is switched from the unlocking interface to the function setting interface for the shortcut switch.

In the case that the intelligent terminal determines the user starts the screen locking service, when the intelligent terminal is awaken from a sleep state, if the intelligent terminal judges the click duration time of the shortcut switch click event exceeds the preset time threshold, the current display interface is switched from the shortcut switch display interface to the unlocking interface, so as to remind the user to input an unlocking password. The intelligent terminal matches the unlocking password inputted by the user with the set password, if the matching succeeds, the current display interface is switched from the unlocking interface to the function setting interface for the shortcut switch. If the matching fails, the user is reminded to input the unlocking password again. If the intelligent terminal detects the number of failed matching exceeds the preset failure threshold, the screen of the intelligent terminal is locked for a preset time length. For example, if the duration time for user's click on the GPS switch in the shortcut switch display interface exceeds the preset threshold, the intelligent terminal switches the current display interface to the unlocking interface, so as to remind the user to input an unlocking password. When the unlocking succeeds, the intelligent terminal switches current display unlocking interface to the function setting interface for the GPS switch.

If the intelligent terminal is in a normal operating state, the intelligent terminal monitors the shortcut switch click event inputted by the user, and the click duration time of the shortcut switch click event exceeds the preset time threshold, the interface is switched directly without the screen unlocking operations.

### The Third Embodiment

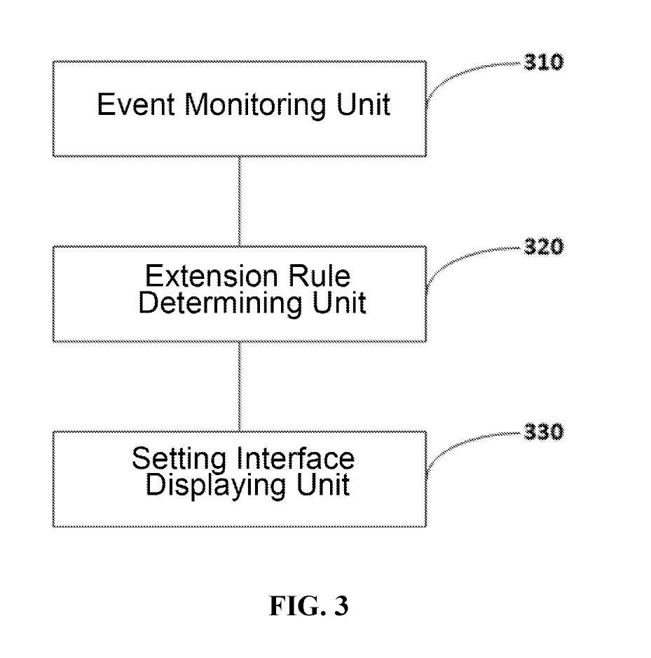

FIG. 3 is a structural schematic diagram of a device for controlling a shortcut switch according to some embodiments of this application. The device for controlling a shortcut switch includes: an event monitoring unit 310, an extension rule determining unit 320 and a setting interface displaying unit 330.

The event monitoring unit 310 is configured to monitor the input shortcut switch click event;

the extension rule determining unit 320 is configured to determine whether the shortcut switch click event satisfies a set extension rule if the occurrence of the shortcut switch click event is monitored; and

the setting interface displaying unit 330 is configured to display the function setting interface for the shortcut switch if the shortcut switch click event satisfies the set extension rule.

In this embodiment, the event monitoring unit 310 monitors the shortcut switch click event inputted by the user; the extension rule determining unit 320 determines whether the shortcut switch click event satisfies the set extension rule if the occurrence of the shortcut switch click event is monitored; the setting interface displaying unit 330 displays the function setting interface for the shortcut switch if the shortcut switch click event satisfies the set extension rule, reducing the cumbersome operations that the user must select the icon in sequence via the setting interface to enter the function setting interface, displaying rapidly and conveniently the function setting interface for the shortcut switch, such that the user's operation can be more convenient, and user's application experience can be improved.

Optionally, the extension rule determining unit 320 includes:

a time judging subunit configured to judge whether a click duration time of the shortcut switch click event exceeds a preset time threshold.

Optionally, the time judging subunit is configured to:

start a preset timer when the occurrence of the shortcut switch click event is monitored;

stop the timer when the termination of the shortcut switch click event is determined, and take the time recorded by the timer as a duration time of the shortcut switch click event; and

judge whether the duration time exceeds to a preset time threshold.

Optionally, the device further includes:

a state changing unit configured to change an opened or closed state of a service corresponding to the shortcut switch click event if the shortcut switch click event doesn't satisfy the set extension rule after determining whether the shortcut switch click event satisfies the set extension rule.

Optionally, the setting interface displaying unit 330 is configured to:

determine whether to perform an unlocking operation when the current shortcut switch display interface is switched to the function setting interface if the shortcut switch click event satisfies the set extension rule;

if an unlocking operation needs to be performed when switching the interface, the current shortcut switch display interface is switched to an unlocking interface, after a successful unlocking, the unlocking interface is switched to the function setting interface for the shortcut switch; and

if an unlocking operation needs not to be performed when switching the interface, the current shortcut switch display interface is switched to the function setting interface for the shortcut switch.

The above device for controlling a shortcut switch can perform any method for controlling a shortcut switch provided in any embodiments of this application, and have corresponding function modules and beneficial effects.

### The Fourth Embodiment

The fourth Embodiment of this application provides a non-transitory computer storage medium having stored thereon computer-executable instructions for performing any of the above-described methods for controlling a shortcut switch.

### The Fifth Embodiment

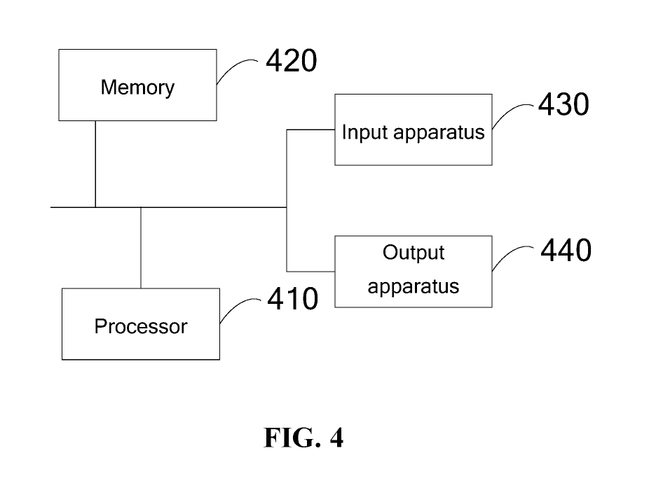

FIG. 4 is a structural schematic diagram of hardware of an electronic device for performing a method for controlling a shortcut switch according to some embodiments of this application. As shown in FIG. 4, the electronic device includes:

one or more processors 410 and a memory 420, one processor 410 is taken as an example in FIG. 4.

The device also can include: an input apparatus 430 and an output apparatus 440.

The processor 410, the memory 420, the input apparatus 430 and the output apparatus 440 in the device for performing the method for controlling a shortcut switch can be connected by a bus or other means, the bus connection is taken as an example in FIG. 4.

The memory 420, as a non-transitory computer-readable storage medium, can be used to store a non-transitory software program, a non-transitory computer-executable program and module, such as the program instruction/module corresponding to the method for controlling the shortcut switch according to embodiments of this application (for example, the event monitoring unit 310, the extension rule determining unit 320 and the setting interface displaying unit 330 shown in FIG. 3). The processor 410 can perform various functional applications and data processing of the server by running the non-transitory software program, instruction and module stored in the memory 420, that is, the method for controlling the shortcut switch according to the above method embodiment is achieved.

The memory 420 can include a storage program area and a storage data area. The storage program area can store an operating system and an application program required by at least one function; the storage data area can store data created based on the use of the device for controlling the shortcut switch. Besides, the memory 420 can include a high-speed random access memory, and also a non-transitory memory, such as at least one magnetic disk storage device, flash memory device or other non-transitory solid state storage device. In some embodiments, the memory 420 optionally includes memories remotely configured relative to the processor 410, these remote memories can be connected to the device for controlling the shortcut switch through the network. Examples of the network include, but are not limited to, the Internet, an intranet, a local area network, a mobile communication network and combinations thereof.

The input apparatus 430 can receive the input figure or character information, generate key signal input associated with the user setting and functional control of the device for controlling the shortcut switch. The output apparatus 440 can include a display device, such as a display screen.

One or more modules are stored in the memory 420, when one or more modules are executed by the one or more processors 410, the method for controlling a shortcut switch in any of the above method embodiments is performed.

The electronic device in embodiments of this application exists in various forms, including but not limited to:

(1) mobile telecommunication device. A device of this kind has a feature of mobile communicating function, and has a main object of providing voice and data communication. Devices of this kind include smart phone (such as IPHONE), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as IPAD;

(3) portable entertainment device. A device of this kind can display and play multi-media content. Devices of this kind include audio and video player (such as IPOD), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for controlling a shortcut switch, comprising:
at an electronic device for controlling the shortcut switch:
monitoring a shortcut switch click event;
determining whether the shortcut switch click event satisfies a set extension rule if the occurrence of the shortcut switch click event is monitored; and
displaying a function setting interface for the shortcut switch if the shortcut switch click event satisfies the set extension rule.

2. The method according to claim 1, wherein determining whether the shortcut switch click event satisfies the set extension rule comprises:
judging whether a click duration time of the shortcut switch click event exceeds a preset time threshold.

3. The method according to claim 2, wherein judging whether the click duration time of the shortcut switch click event exceeds the preset time threshold comprises:
starting a preset timer when the occurrence of the shortcut switch click event is monitored;
stopping the timer when the termination of the shortcut switch click event is determined, and taking the time recorded by the timer as a duration time of the shortcut switch click event; and
judging whether the duration time exceeds to the preset time threshold.

4. The method according to claim 1, after determining whether the shortcut switch click event satisfies the set extension rule, the method further comprises:
changing the opened or closed state of a service corresponding to the shortcut switch click event if a shortcut switch click event doesn't satisfy the set extension rule.

5. The method according to claim 1, wherein displaying the function setting interface for the shortcut switch if the shortcut switch click event satisfies the set extension rule, comprises:
determining whether to perform an unlocking operation when the current shortcut switch display interface is switched to the function setting interface if the shortcut switch click event satisfies the set extension rule;
if an unlocking operation is required to be performed when switching the interface, the current shortcut switch display interface is switched to an unlocking interface, after a successful unlocking, the unlocking interface is switched to the function setting interface for the shortcut switch; and
if the unlocking operation is not required to be performed when switching the interface, the current shortcut switch display interface is switched to the function setting interface for the shortcut switch.

6. An electronic device, comprising:
at least one processor; and
a memory communicably connected with the at least one processor for storing instructions executable by the at least one processor, wherein execution of the instructions by the at least one processor causes the at least one processor to:
monitor a shortcut switch click event;
determine whether the shortcut switch click event satisfies a set extension rule if the occurrence of the shortcut switch click event is monitored; and
display the function setting interface for the shortcut switch if the shortcut switch click event satisfies the set extension rule.

7. The electronic device according to claim 6, wherein the execution of the instructions by the at least one processor further causes the at least one processor to:
judge whether a click duration time of the shortcut switch click event exceeds a preset time threshold.

8. The electronic device according to claim 7, wherein the execution of the instructions by the at least one processor further causes the at least one processor to
start a preset timer when the occurrence of the shortcut switch click event is monitored;
stop the timer when the termination of the shortcut switch click event is determined, and take the time recorded by the timer as a duration time of the shortcut switch click event; and
judge whether the duration time exceeds to a preset time threshold.

9. The electronic device according to claim 6, execution of the instructions by the at least one processor further causes the at least one processor to:
change an opened or closed state of a service corresponding to the shortcut switch click event if the shortcut switch click event doesn't satisfy the set extension rule after determining whether the shortcut switch click event satisfies the set extension rule.

10. The electronic device according to claim 6, wherein the execution of the instructions by the at least one processor further causes the at least one processor to:
determine whether to perform an unlocking operation when the current shortcut switch display interface is switched to the function setting interface if the shortcut switch click event satisfies the set extension rule;
if an unlocking operation is required to be performed when switching the interface, the current shortcut switch display interface is switched to an unlocking interface, after a successful unlocking, the unlocking interface is switched to the function setting interface for the shortcut switch; and
if the unlocking operation is not required to be performed when switching the interface, the current shortcut switch display interface is switched to the function setting interface for the shortcut switch.

11. A non-transitory computer-readable storage medium storing executable instructions that, when executed by an electronic device, cause the electronic device to:
monitor a shortcut switch click event;
determine whether the shortcut switch click event satisfies a set extension rule if the occurrence of the shortcut switch click event is monitored; and
display a function setting interface for the shortcut switch if the shortcut switch click event satisfies the set extension rule.

12. The non-transitory computer-readable storage medium according to claim 11, wherein when determining whether the shortcut switch click event satisfies the set extension rule, the executable instructions cause the electronic device to:
judge whether a click duration time of the shortcut switch click event exceeds a preset time threshold.

13. The non-transitory computer-readable storage medium according to claim 12, wherein when judging whether a click duration time of the shortcut switch click event exceeds a preset time threshold, the executable instructions cause the electronic device to:
start a preset timer when the occurrence of the shortcut switch click event is monitored;
stop the timer when the termination of the shortcut switch click event is determined, and take the time recorded by the timer as a duration time of the shortcut switch click event; and
judge whether the duration time exceeds to the preset time threshold.

14. The non-transitory computer-readable storage medium according to claim 11, wherein after determining whether the shortcut switch click event satisfies the set extension rule, the executable instructions cause the electronic device to:
change the opened or closed state of a service corresponding to the shortcut switch click event if a shortcut switch click event doesn't satisfy the set extension rule.

15. The non-transitory computer-readable storage medium according to claim 11, wherein when displaying a function setting interface for the shortcut switch if the shortcut switch click event satisfies the set extension rule, the executable instructions cause the electronic device to:
determine whether to perform an unlocking operation when the current shortcut switch display interface is switched to the function setting interface if the shortcut switch click event satisfies the set extension rule;
if an unlocking operation is required to be performed when switching the interface, the current shortcut switch display interface is switched to an unlocking interface, after a successful unlocking, the unlocking interface is switched to the function setting interface for the shortcut switch; and
if the unlocking operation is not required to be performed when switching the interface, the current shortcut switch display interface is switched to the function setting interface for the shortcut switch.
